(19) United States
(12) Patent Application Publication
(10) Pub. No.: US 2018/0339906 A1
(43) Pub. Date: Nov. 29, 2018

(54) PREPARATION METHOD FOR LARGE-SIZE GRAPHENE OXIDE OR GRAPHENE

(71) Applicant: FUDAN UNIVERSITY, Shanghai (CN)

(72) Inventors: Hongbin LU, Shanghai (CN); Lei DONG, Shanghai (CN); Shan LIN, Shanghai (CN); Chen MA, Shanghai (CN)

(21) Appl. No.: 15/776,746

(22) PCT Filed: Nov. 15, 2016
(86) PCT No.: PCT/CN2016/105943

§ 371 Date: May 16, 2018

(30) Foreign Application Priority Data
Nov. 16, 2015 (CN) 201510777025.7

(51) Int. Cl. C01B 32/192; C01B 32/198

(52) U.S. Cl. CPC C01B 32/192; C01B 32/198; C01B 2204/04; B82Y 30/00; C01B 2204/22; C01B 2204/02; C01B 2204/32

(57) ABSTRACT

Provided are a preparation method for large-size graphene oxide or graphene, a graphene material, and a product. The method comprises: by means of an intercalating agent and an expanding agent, widening the interlayer space in graphite to weaken interlayer interaction forces, thereby obtaining a graphene aggregate; after oxidizing the graphene aggregate by using an oxidizing agent, exfoliating the graphene aggregate in water by using gentle mechanical means, thereby obtaining a dispersion containing large graphene oxide flakes; and reducing the exfoliated graphene oxide by using a reducing agent or thermal treatment, thereby obtaining high-conductivity graphene. The method avoids the damage to a graphene oxide crystal structure caused by high-energy ultrasonic waves, high-speed shearing, or fluid pulverizing; and the obtained graphene is large in size and high in conductivity, and can be used in the fields of high-efficiency heat management, flexible display, energy conversion and storage, and the like.

### TECHNICAL FIELD

The invention belongs to the technical field of preparation of graphene oxide and graphene, and relates to a method for preparing large-size graphene oxide or graphene on a large scale, in particular, taking graphite as a raw material, obtaining graphene oxide aggregate through intercalation, expansion and oxidation processes, exfoliating under the effect of gentle mechanical force thereby obtaining large-size graphene oxide, and then obtaining large-size graphene through reduction.

### BACKGROUND ART

The transparent conductive film has high light transmittance and excellent conductivity, and has broad application prospects in the fields of liquid crystal displays, solar cells, light emitting diodes, intelligent windows and the like. Indium tin oxide (ITO) has been hampered in its application to transparent conductive films because of its disadvantages such as high cost and brittleness. Graphene is the thinnest two-dimensional material in which carbon atoms are sp² hybridized and tightly packed into a monolayer honeycomb structure, having more excellent performances, such as high conductivity, high specific surface area, high strength, high light transmittance, high electron mobility and the like, compared with ITO, and thus gradually developed into an ideal material for the preparation of transparent conductive film. Although researchers at home and abroad have invested a large amount of funds and manpower to develop large-scale preparation technologies for graphene, the graphene sheets obtained by the currently disclosed technology are small in size, resulting in more overlaps inside transparent conductive films and large charge transport resistance, thereby seriously affecting the conductive properties of the conductive film. The large-size graphene sheets can effectively form a connected and bridged network structure in the matrix of the constructed material thereby reducing interlayer overlap and interface contact resistance. Therefore, it is a key problem that needs to be solved urgently to develop a large-scale, low-cost method for preparing large-size graphene oxide and high-conductivity graphene.

At present, a high-quality graphene with a thickness of about 10 μm can be prepared by micromechanical exfoliation using a transparent tape, but this method has a low yield, is not easy to obtain an independent graphene sheet having monoatomic layer thickness, which is also not suitable for large-scale production and application. CVD can achieve graphene growth in large-area, but it is more difficult to transfer graphene to other substrates. Due to the mechanical force of ultrasonic and high-speed shear, the method of liquid phase exfoliation and the like make the graphene oxide or graphene undergo a strong impact and easily break into several micrometer- or even nanometer-sized sheets, and it is difficult to obtain large-size graphene oxide and graphene sheets. For the preparation of large-size graphene oxide and graphene sheets, the redox method is still the most effective method. However, the key challenge of this method is how to solve the difficulty in solid-liquid separation of high-viscosity graphene oxide suspensions, and destruction of the sheet by the externally input energy during exfoliating. Therefore, how to obtain large-size graphene oxide and graphene with high yield is still a key bottleneck restricting the application of graphene.

Common Brodie and Staudernmaie oxidation methods require prolonged oxidation and degrees of oxidation are relatively low. Although Hummers method has a high degree of oxidation, it needs to go through three tedious stages. These methods cause the graphene sheets to undergo severe and vigorous oxidation and continuous centrifugal washing process at later stages which inevitably destroy the lattice structure of graphene and introduce a large number of defects, resulting in a serious loss of the intrinsic properties of graphene. The Chinese patent “Preparation method of large-size graphene oxide” (CN 103408000A) uses flake graphite as a raw material, which is firstly intercalated with hydrogen peroxide, and then oxidized under ultrasound to prepare graphene oxide. Although this method has high oxidation efficiency and exfoliating efficiency, it involves ultrasound assistance, so it is inevitable to reduce the size of graphene to a certain extent, and the difficulty of solid-liquid separation of graphene oxide suspension cannot be solved. The patent “Method for preparing graphene fibers through self-assembly of large lamellar graphene oxide” (CN103741264A) firstly intercalates graphite with strong acids, expands at high temperature, and then oxidizes by Hummers method, centrifuges and dialyzes to obtain graphene sheets, whose radial dimension is smaller (20˜80 μm). The preparation process is complicated and the cost is high. In 2014, Nature Communications reported a method for preparing monolayer graphene oxide within 1 h (DOI: 10.1038/ncomms6716). However, this method is only suitable for small-size graphite materials, although it is environmentally friendly. At present, how to prepare large-size graphene oxide and high-conductivity graphene with high efficiency and high yield has not been disclosed and reported yet.

### SUMMARY OF THE INVENTION

The present invention fundamentally solves the difficulties encountered in the preparation of large-size graphene oxide and graphene as described above. The purpose of the present invention is to develop a method for preparing large-size graphene oxide and graphene at low cost and with high efficiency. The method has the advantages of simple operation procedure, safety, high efficiency, low cost and the like, is particularly suitable for large-scale industrial production, and has a wide industrial application prospect.

The first aspect of the present invention provides a method for preparing large-size graphene oxide or graphene. Firstly, a graphite is intercalated with an intercalating agent, and then the intercalated graphite is expanded with an expanding agent to release the interlayer space and weaken the interlayer interaction forces and then oxidized by an oxidizing agent, and exfoliated under a gentle mechanical action to form a uniform graphene oxide dispersion liquid, which is finally reduced by using a reducing agent or a heat treatment to obtain a large-size graphene; The characteristic is that the specific steps are as follows.

(1) The graphite and the intercalating agent are stirred and reacted at 0-130° C. for 5 minutes to 48 hours, then added into the expanding agent and soaked at 0-80° C. for 1 hour to 7 days so that the interlayer space is fully released to obtain a graphene aggregate.

(2) The graphene aggregate obtained in step (1) is added into a mixture of an acid and an oxidizing agent, soaked or refluxed at 0-130° C. for 0.1-50 hours, then filtered and washed with deionized water to remove impurities to obtain an oxidized graphene aggregate.

(3) The oxidized graphene aggregate obtained in step (2) is mixed with deionized water and exfoliated under a gentle mechanical action to obtain a graphene oxide dispersion liquid, and the graphene oxide is reduced by using a reducing agent or heat treatment thereby obtaining a large-size, high-conductivity graphene suspension liquid, wherein the content of the graphene oxide aggregate in the suspension liquid is 0.1-50 mg/ml; the film thickness is 1-25 μm after the formed graphene oxide film undergoes the heat treatment.

(4) The graphene oxide dispersion liquid or the reduced graphene suspension liquid obtained in step (3) is centrifuged or concentrated by evaporation to obtain graphene oxide or graphene slurry having a high solid content; or is subjected to freeze drying or spray drying to prepare the corresponding graphene oxide or graphene powder.

It should be noted that the above mechanism description does not limit the protection scope of the present invention, and the preparation method in the present invention is mainly limited by the steps.

In the present invention, the raw material graphite described in step (1) refers to flake graphite, artificial graphite, expandable graphite and expanded graphite, wherein the carbon content is greater than 95% and the radial dimension is less than 5 mm.

In the present invention, the intercalating agent described in step (1) refers to ammonium persulfate, potassium dichromate, chromium trioxide, potassium permanganate, potassium ferrate, concentrated sulfuric acid, concentrated hydrochloric acid, concentrated nitric acid, perchloric acid, concentrated phosphoric acid or glacial acetic acid, or any combination thereof, the amount of the intercalating agent is 0.1-20 times that of the raw material graphite, and the concentration of concentrated sulfuric acid, concentrated hydrochloric acid, concentrated nitric acid, perchloric acid, concentrated phosphoric acid or glacial acetic acid used is 10-20 mol/L.

In the present invention, the expanding agent described in step (1) refers to one or more of ammonium oxalate, oxalic acid, potassium oxalate, hydrogen peroxide, sodium carbonate and sodium bicarbonate aqueous solution, its molar concentration is 0.1-10 mol/L, and the amount of the expanding agent is 1-500 times that of the raw material graphite.

In the present invention, the acid described in step (2) refers to one or more of concentrated sulfuric acid, concentrated nitric acid, perchloric acid, concentrated phosphoric acid, formic acid, oxalic acid and glacial acetic acid, and the amount of the acid is 1-200 times that of the raw material graphite.

In the present invention, the oxidizing agent described in step (2) refers to one of ammonium persulfate, potassium dichromate, potassium permanganate, potassium ferrate, sodium nitrate, potassium nitrate and concentrated nitric acid, or a mixture thereof in any ratio, the amount of the oxidizing agent is 0.1-10 times that of the raw material graphite.

In another preferred embodiment, the mass ratio of the oxidizing agent to the raw material graphite is 0.1-10, preferably 1.5-6.0, more preferably 1.8-4.0, and most preferably 2.0-3.0.

In the present invention, the gentle mechanical action described in step (3) refers to one of magnetic stirring, mechanical stirring, kneading device, shaker and oscillator, the rotational speed is 10-1000 rpm and the time is 1-120 minutes.

In the present invention, the reducing agent described in step (3) refers to one of hydrazine hydrate, hydroiodic acid, lithium aluminum hydride, sodium borohydride, sodium hydroxide, sodium citrate and ascorbic acid, or a mixture thereof in any ratio, the amount of the reducing agent is 0.1-10 times that of the raw material graphite. The heat treatment refers to a reduction treatment for graphene oxide at 200-2000° C. and the treatment time is 1 second to 60 minutes.

In another preferred embodiment, the graphene oxide or graphene has a radial dimension in the range of 85-500 μm.

In another preferred embodiment, 75% or more of the graphene material is a monolayer graphene.

In another preferred embodiment, in the step (1), the mass of the graphite as a raw material is ≥0.1 g, preferably ≥0.5 g, more preferably ≥5.0 g, and most preferably ≥100 g.

The second aspect of the present invention provides a graphene material having a radial dimension in the range of 85-500 μm, and the mass fraction of monolayer graphene in the graphene material is ≥75% (preferably ≥85%, more preferably ≥90%, and most preferably ≥95%).

In another preferred embodiment, the graphene material has a conductivity of 500-10⁵ S/cm, preferably 550-10⁴ S/cm, more preferably 600-9000 S/cm and most preferably 800-9000 S/cm.

The radial dimension of the large sheet of graphene oxide and graphene prepared by the method described in the present invention is 20-500 μm or more, and the conductivity of the reduced graphene can reach 600 S/cm or more.

The third aspect of the present invention provides an article comprising the graphene material according to the second aspect of the present invention or prepared from the graphene material according to the second aspect of the present invention.

The fourth aspect of the present invention provides a method for preparing graphene, comprising the steps of:

(a) reacting a graphite with an intercalating agent under stirring at 0-130° C.;

(b) mixing the stirred reaction product with an expanding agent to obtain a graphene aggregate;

(c) mixing the graphene aggregate obtained in step (b) with an acid and an oxidizing agent to obtain an oxidized graphene aggregate;

(d) mixing the oxidized graphene aggregate obtained in step (c) with deionized water and obtaining graphene oxide after exfoliating;

(e) optionally, reducing the graphene oxide obtained in step (d) by using a reducing agent or heat treatment to obtain a large-size, high-conductivity graphene suspension liquid or graphene film.

In another preferred embodiment, all steps in the preparation method described in the first aspect of the present invention can be used in the third aspect of the present invention.

Compared with the prior art, the present invention has the following advantages:

(1) The graphene oxide and graphene prepared by the technology of the present invention have large size, good quality, and uniform structure, and the yield is close to 100%, and the monolayer rate is 90% or more. The raw material graphite has wide sources and low cost, and is convenient for large-scale industrial production.

(2) The preparation process of the present invention is simple, does not need any expensive special equipment or high-temperature expansion conditions such as microwave reactor, high-temperature furnace and the like, and avoids the problem of uneven expansion generated during rapid thermal expansion process.

(3) Compared with the traditional preparation method of graphene oxide, in the present invention the reaction time is short and the dosage of the oxidizing agent is low.

(4) The acid and the oxidizing agent used in the oxidation process of the present invention can be recovered and recycled to avoid the pollution of the waste acid to the environment.

(5) The graphene oxide aggregate prepared by the present invention can achieve rapid solid-liquid separation, washing and exfoliating, and effectively solve the key problems in the preparation and purification of graphene oxide.

(6) The size of the graphene oxide and the graphene sheet prepared by the present invention is much larger than that of the sample or product prepared by the currently disclosed or reported method, and the oxygen-containing functional group is more evenly and controllably distributed on the surface of the graphene.

(7) The preparation technology of the large-size graphene oxide and graphene prepared by the present invention has high exfoliating efficiency, and the yield is almost 100%. The graphene oxide or graphene having an average side size of more than 100 microns can be obtained without grading.

(8) The present invention has mild reaction condition, simple process, low energy consumption, low production cost and high efficiency. The obtained grapheme has large size and high electrical conductivity, and the method of the invention is convenient for large-scale industrial production.

### BRIEF DESCRIPTION OF DRAWINGS

FIG. 1 is a scanning electron microscope image (SEM) of the super-sized graphene oxide.

FIG. 2 is an SEM image of (a) the appearance and (b) the thickness direction of the reduced graphene oxide film.

### DETAILED DESCRIPTION OF THE INVENTION

The present invention will be further described below with reference to the drawings and specific embodiments. The following examples are intended to understand the present invention and do not limit the content of the invention. It should be understood that the one or more steps mentioned in the present invention do not exclude other methods and steps before or after the combination step, or other methods and steps may also be interposed between these explicitly mentioned steps. It should also be understood that these examples are only for illustrating the present invention and are not intended to limit the scope of the present invention. Unless otherwise indicated, the numbering of each method step is only for the purpose of identifying each method step, and is not intended to limit the arrangement order of each method or to limit the scope of implementation of the present invention, and the change or adjustment of the relative relationship of the number without substantial technical content can be also considered to be an implementable scope of the present invention.

### Terms

Radial Dimension

As used herein, the “radial dimension”, i.e., lateral size, also referred to as “side size”, refers to the largest dimension in the XY plane, not the thickness direction (z direction).

In another preferred embodiment, the graphene oxide material of the present invention has a radial dimension in the range of 85-500 μm, preferably 100-470 μm, more preferably 150-450 μm, and most preferably 200-400 μm.

Expanding Agent

As used herein, the expanding agent expands the intercalated graphite to release the interlayer space and weaken the interlayer interaction forces.

The expansion according to the present invention is performed at 0-80° C. using one or more expanding agents selected from the group consisting of ammonium oxalate, oxalic acid, potassium oxalate, hydrogen peroxide, sodium carbonate and sodium bicarbonate solution. The solvent may be water or other solvents well known to those skilled in the art.

The expansion according to the present invention is a liquid-state expansion rather than a solid-state expansion, and the operation is simple and the cost is lower.

Graphene Oxide and Graphene

As used herein, a person skilled in the art can prepare graphene oxide, as well as graphene after reduction with a reducing agent or after high temperature reduction as needed.

In another preferred embodiment, graphene oxide serves as an intermediate for preparing graphene.

In another preferred embodiment, graphene after reduction exhibits significantly increased conductivity.

### Example 1

50 mL of concentrated sulfuric acid and 5 g of ammonium persulfate were mixed and stirred at 5° C. for 10 min. 1 g of flake graphite was added and stirred continuously at 20° C. in a water bath for 10 h to obtain intercalated graphites (GICs).

Then the obtained intercalated graphites were slowly added into 200 mL of 0.1 mol/L oxalic acid solution. After quickly reacting at room temperature for 2 d, the mixture was filtered and washed with water to obtain graphene aggregate.

The obtained graphene aggregate was slowly added into a mixture of 40 mL of concentrated sulfuric acid and 2 g of potassium permanganate, and the mixture was left to stand at 35° C. for 6 hours, then filtrated and washed with water. 1 L of deionized water was added and the mixture was shaken on an oscillating bed at 500 rpm for 10 minutes to obtain a uniform graphene dispersion liquid.

The microscopic results show that the average radial dimension of the graphene oxide thus obtained can reach more than 100 micrometers, and 90% or more is a monolayer.

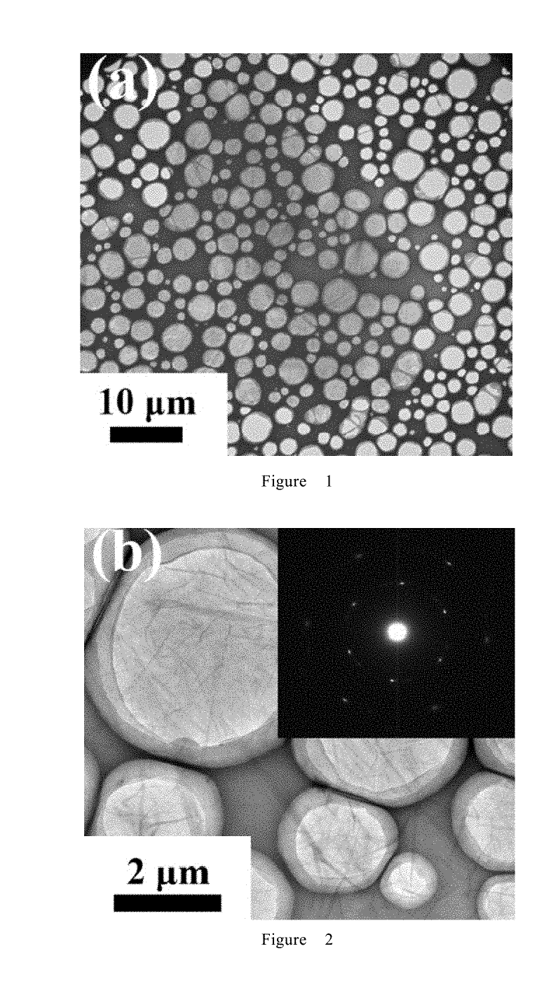

FIG. 1 is an SEM image of the resulting graphene oxide sheet with a radial dimension of up to 450 microns.

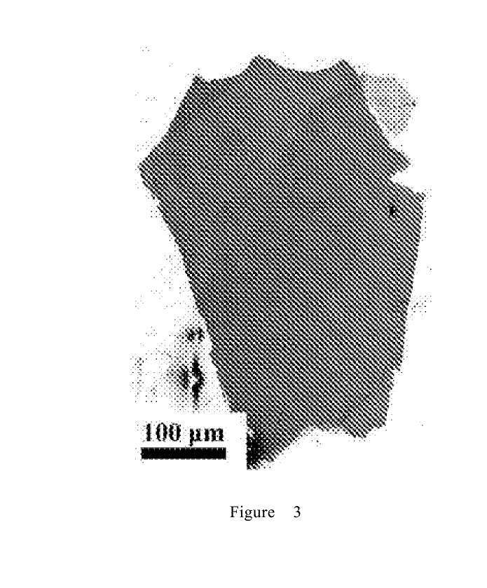

FIG. 2 shows the SEM image of the graphene film appearance (a) and the thickness direction after reduction with a solution of hydroiodic acid (57%) at 60° C. for 2 h, indicating that its thickness is ˜1.5 μm. The measurement results of the four-probe shows that its conductivity is 600 S/cm or more.

### Example 2

The graphene oxide suspension liquid obtained in example 1 was filtrated, formed into a film, and then heat-treated at 800° C. for 60 minutes and pressed at a pressure of 20 MPa for 5 minutes. The measurement results of the four-probe shows that the film conductivity reaches 600 S/cm or more.

### Example 3

Concentrated sulfuric acid (30 mL) and concentrated nitric acid (10 mL) were mixed and stirred at 5° C. in an ice-water bath for 10 min. 1 g of flake graphite was added and stirred continuously at 20° C. in a water bath for 6 h followed by filtration to obtain GICs.

Then, GICs were slowly added to 200 mL of 0.1 mol/L oxalic acid solution. After reacting for 1 d at room temperature, the mixture was filtered and washed with water to obtain graphene aggregate.

The graphene aggregate was slowly added into a mixture of 40 mL of concentrated sulfuric acid and 2 g of potassium permanganate. The mixture was left to stand at 35° C. for 6 hours, and then filtrated and washed with water. 1 L of deionized water was added and the mixture was shaken on an oscillating bed at 500 rpm for 10 minutes to obtain graphene oxide. The average radial dimension of graphene oxide obtained is more than 100 microns, and 90% or more is a monolayer. After the graphene oxide was reduced by a hydroiodic acid solution (57%) at 60° C. for 2 hours, the electrical conductivity reached 600 S/cm or more.

### Example 4

1 g of flake graphite (with a carbon content of >95%), 5 g of chromium trioxide and 2 g of potassium permanganate were mixed, and then 12 mL of glacial acetic acid (99.5%) was added. The reaction mixture was stirred in a water bath at 45° C. for 2 d and then filtered to obtain GICs.

Then, 200 mL of hydrogen peroxide (30%) was added. After reacting at room temperature for 2 days, the mixture was filtered and washed with water to obtain graphene aggregate.

Then, the graphene aggregate was then slowly added into a mixture of 40 mL of concentrated sulfuric acid and 2 g of potassium permanganate. The mixture was left to stand at 35° C. for 6 hours, filtered, and washed with water. 1 L of deionized water was added and the mixture was stirred under magnetic stirring at 500 rpm for 10 minutes to obtain graphene oxide. The average radial dimension of the obtained graphene oxide was 100 μm or more, and about 90% was monolayer. After the graphene oxide was reduced by a hydroiodic acid solution (57%) at 60° C. for 2 hours, the electrical conductivity reached 600 S/cm or more.

### Example 5

1 g of flake graphite (with a carbon content of 95% or more) was mixed with 20 g of chromium trioxide, then 15 mL of concentrated hydrochloric acid (38%) was added, and the mixture was stirred at 25° C. in a water bath. After 2 h, the mixture was filtered, washed with water and acetone several times to obtain GICs.

Then, 200 mL of hydrogen peroxide (30%) was added, and the mixture was reacted at room temperature for 2 days and then filtrated and washed with water to obtain expanded graphite which was then slowly added to 40 mL of concentrated sulfuric acid and 2 g of potassium permanganate. The mixture was stirred at room temperature for 6 h, filtered and washed with water. 1 L of deionized water was added and the mixture was stirred under magnetic stirring at 500 rpm for 10 minutes to obtain a graphene oxide suspension liquid.

The resulting graphene oxide was reduced in a hydroiodic acid solution (57%) at 60° C. for 2 hours to obtain a large-size graphene whose sheet had an average radial dimension of 100 μm or more and a conductivity of 600 S/cm or more.

### Example 6

1 g of flake graphite (with a carbon content of 95% or more) was mixed with 3 g of chromium trioxide, and 10 mL of glacial acetic acid (99.5%) was added. After refluxing at 122° C. for 2 hours, the mixture was filtered, and washed repeatedly with water and acetone to obtain GICs.

Then, 200 mL of hydrogen peroxide (30%) was added. The mixture was reacted at room temperature for 2 days, followed by being filtrated and washed with water to obtain graphene aggregate.

The graphene aggregate was then was slowly added into a mixture of 40 mL of concentrated sulfuric acid and 2 g of potassium permanganate, and the mixture was left to stand at 35° C. for 6 hours and then filtrated and washed with water. 1 L of deionized water was added and the mixture was stirred at 500 rpm with magnetic stirring for 10 min. The obtained graphene oxide had an average radial dimension of 100 μm or more, and 90% or more was a monolayer. After 2 hours of reduction with a hydroiodic acid solution (57%) at 60° C., the conductivity reached 600 S/cm or more.

### Example 7

1 g of flake graphite (with a carbon content of 95% or more) was mixed with 5 g of chromium trioxide, and then 50 mL of glacial acetic acid (99.5%) was added. After reacting at 80° C. for 2 hours, the mixture was filtered, and washed with water and acetone several times to obtain GICs.

Then, 200 mL of hydrogen peroxide (30%) was added and after reacting at room temperature for 2 days, the mixture was filtered and washed with water to obtain worm-like graphene aggregate which was then slowly added into a mixture of 40 mL of concentrated sulfuric acid and 2 g of potassium permanganate (previously mixed). The mixture was allowed to stand at 35° C. for 6 hours, and then filtrated and washed with water. 1 L of deionized water was added and the mixture was stirred under magnetic stirring at 500 rpm for 10 minutes. The average radial dimension of the obtained graphene oxide was 100 μm or more, and 90% or more was monolayer. After 2 hours of reduction with a hydroiodic acid solution at 60° C. (57%), the conductivity reached 600 S/cm or more.

### Example 8

1 g of flake graphite (with a carbon content of 95% or more) was mixed with 8.5 g of chromium trioxide, and then 7 mL of concentrated hydrochloric acid (38%) was added. The mixture was stirred at 25° C. in a water bath. After 2 h, the mixture was filtered, and washed with water and acetone several times to obtain GICs.

Then, 200 mL of hydrogen peroxide (30%) was added and after reacting at room temperature for 2 days, the mixture was filtered and washed with water to obtain worm-like graphene aggregate which was then slowly added into a mixture of 40 mL of concentrated sulfuric acid and 2 g of potassium permanganate. The mixture was left to stand at 35° C. for 6 hours and then filtrated and washed with water. 1 L of deionized water was added and the mixture was shaken on an oscillating bed at 500 rpm for 10 minutes. The average radial dimension of graphene oxide obtained was 100 μm or more, and 90% or more is a monolayer. After 2 hours of reduction with a hydroiodic acid solution (57%) at 60° C., the conductivity reached 650 S/cm or more.

### Example 9

1 g of flake graphite (with a carbon content of 95% or more) was mixed with 8.5 g of chromium trioxide, and then 7 mL of concentrated hydrochloric acid (38%) was added. The mixture was stirred at 25° C. in a water bath. After 2 h, the mixture was filtered, repeatedly washed with water and acetone several times to obtain GICs.

Then, 200 mL of hydrogen peroxide (30%) was added. After reacting for 2 days at room temperature, the mixture was filtered and washed with water to obtain worm-like graphene aggregate.

Then the graphene aggregate was slowly added into a mixture of 40 mL of concentrated sulfuric acid and 2 g of potassium permanganate. The mixture was left to stand at 35° C. for 6 hours, filtered, and washed with water. 1 L of deionized water was added and the mixture was shaken on an oscillating bed at 500 rpm for 10 minutes. The average radial dimension of the obtained graphene oxide reached 100 μm or more, and 90% or more was a single layer. After 2 hours of reduction with hydrazine hydrate (64%) at 80° C., the conductivity reached 600 S/cm or more.

### Example 10

1 g of flake graphite (with a carbon content of 95% or more) was mixed with 8.5 g of chromium trioxide, and then 7 mL of concentrated hydrochloric acid (38%) was added. The mixture was stirred at 25° C. in a water bath. After 2 h, the mixture was filtered, repeatedly washed with water and acetone several times to obtain GICs.

Then, 200 mL of hydrogen peroxide (30%) was added. After reacting at room temperature for 2 days, the mixture was filtered and washed with water to obtain worm-like graphene aggregate.

Then the graphene aggregate was slowly added into a mixture of 40 mL of concentrated sulfuric acid and 2 g of potassium permanganate, and the mixture was left to stand at 35° C. for 6 hours, filtered, and washed with water. 1 L of deionized water was added and the mixture was mixed in a mixer at 300 rpm for 10 min. The average radial dimension of graphene oxide obtained reached 100 μm or more, and 90% or more was monolayer. After 2 hours of reduction with a hydroiodic acid solution (57%) at 60° C., the conductivity reached 600 S/cm or more.

### Example 11

1 g of flake graphite (with a carbon content of 95% or more) was mixed with 8.5 g of chromium trioxide, and then 7 mL of concentrated hydrochloric acid (38%) was added. The mixture was stirred at 25° C. in a water bath. After 2 h, the mixture was filtered, repeatedly washed with water and acetone several times to obtain GICs.

Then, 200 mL of hydrogen peroxide (30%) was added and after reacting at room temperature for 2 days, the mixture was filtered and washed with water to obtain worm-like graphene aggregate.

Then the graphene aggregate was added into a mixture of 50 mL of concentrated nitric acid and 2 g of potassium perchlorate. The mixture was allowed to stand at 35° C. for 6 hours, filtrated and washed with water. 1 L of deionized water was added and the mixture was shaken on an oscillating bed at 500 rpm for 10 min. The average radial dimension of the graphene oxide obtained reached 100 μm or more, and 90% or more was a monolayer. After 2 hours of reduction with a hydroiodic acid solution at 60° C. (57%), the conductivity reached 600 S/cm or more.

### Example 12

Concentrated sulfuric acid (50 mL) and ammonium persulfate (5 g) were mixed and stirred at 5° C. for 10 min. 1 g of flake graphite (with a carbon content of 95% or more) was added and the mixture was stirred continuously at 25° C. in a water bath for 10 h to obtain GICs.

Then, the obtained GICs were slowly added into 200 mL of 0.1 mol/L oxalic acid solution, and after rapidly reacting at room temperature for 2 days, the mixture was filtered and washed with water to obtain worm-like graphene aggregate which was then added to a mixture of 40 mL of concentrated sulfuric acid (98%) and concentrated nitric acid (16 M) (3:1). The mixture was heated under reflux for 1 hour, then filtered, and washed with water. 1 L of deionized water was added and the mixture was shaken for 10 min on an oscillating bed at 500 rpm. The obtained graphene oxide had an average radial dimension of 100 μm or more, and 90% or more was a monolayer. After 2 hours of reduction with a hydroiodic acid solution (57%) at 60° C., the conductivity reached 600 S/cm or more.

### Example 13

50 mL of concentrated sulfuric acid and 5 g of ammonium persulfate were mixed and stirred at 5° C. for 10 min, and 1 g of artificial graphite (with a carbon content of 95% or more) was added. GICs were obtained after continuous stirring at 20° C. in a water bath for 10 h.

Then GICs were slowly added to 200 mL of 0.1 mol/L oxalic acid solution, and after rapidly reacting at room temperature for 2 days, the mixture was filtered and washed with water to obtain graphene aggregate.

Then the graphene aggregate was slowly added to a mixture of 40 mL of concentrated sulfuric acid and 2 g of potassium permanganate. The mixture was left to stand at 35° C. for 6 hours and then filtrated and washed with water. 1 L of deionized water was added and the mixture was shaken for 10 min on an oscillating bed at 500 rpm. The average radial dimension of the graphene oxide obtained reached 100 micrometers or more, and 90% or more is a monolayer. The conductivity is 600 S/cm or more after reduction for 2 h with a hydroiodic acid solution (57%) at 60° C.

### Example 14

Concentrated sulfuric acid (50 mL) and ammonium persulfate (5 g) were mixed and stirred at 5° C. for 10 min. 1 g of expanded graphite (with a carbon content of 95% or more) was added. GICs were obtained after continuous stirring at 20° C. in a water bath for 5 h.

Then GICs were slowly added into 200 mL of 0.1 mol/L oxalic acid solution, and after rapidly reacting at room temperature for 2 days, the mixture was filtered and washed with water to obtain graphene aggregate.

Then the graphene aggregate was slowly added to a mixture of 40 mL of concentrated sulfuric acid and 2 g of potassium permanganate. The mixture was left to stand at 35° C. for 6 hours and then filtrated and washed with water. 1 L of deionized water was added and the mixture was shaken for 10 min on an oscillating bed at 500 rpm. The average radial dimension of the obtained graphene oxide was 100 microns or more, and about 90% was a monolayer. The conductivity reached 600 S/cm or more after the graphene oxide was reduced for 2 hours with a hydroiodic acid solution (57%) at 60° C.

### Example 15

50 mL of concentrated sulfuric acid and 5 g of ammonium persulfate were mixed and stirred at 5° C. for 10 min, and 1 g of expandable graphite (with a carbon content of 95% or more) was added, and the mixture was stirred continuously for 6 h at 20° C. in a water bath to obtain GICs.

Then, the obtained GICs were slowly added into 200 mL of 0.1 mol/L oxalic acid solution, and after rapidly reacting at room temperature for 2 days, the mixture was filtered and washed with water to obtain graphene aggregate.

Then the graphene aggregate was slowly added to a mixture of 40 mL of concentrated sulfuric acid and 2 g of potassium permanganate. The mixture was left to stand at 35° C. for 6 hours, then filtrated and washed with water. 1 L of deionized water was added and the mixture was shaken for 10 min on an oscillating bed at 500 rpm. The average radial dimension of the obtained graphene oxide was 100 micrometers or more, and 90% or more was a monolayer. After the graphene oxide was reduced for 2 hours with a hydroiodic acid solution (57%) at 60° C., the conductivity reached 600 S/cm or more.

### Comparative Example 1

It was mainly the same as example 1. The difference from Example 1 was that it did not include the step of “being slowly added into a mixture of 40 mL of concentrated sulfuric acid and 2 g of potassium permanganate, and the mixture was left to stand for 6 hours at 35° C., then filtrated and washed with water”. The details were as follows.

50 mL of concentrated sulfuric acid and 5 g of ammonium persulfate were mixed and stirred at 5° C. for 10 min, and then 1 g of flake graphite was added. GICs were obtained after continuously stirring for 10 h at 20° C. in a water bath.

Then, GICs were slowly added to 200 mL of 0.1 mol/L oxalic acid solution and after reacting for 2 days at room temperature, the mixture was filtered and washed with water to obtain graphene aggregate. Then, 1 L of deionized water was added and the mixture was shaken for 10 min on an oscillating bed at 500 rpm. As a result, it was found that no exfoliation of aggregate was observed.

The results showed that the reoxidation of the graphene aggregate by potassium permanganate and concentrated sulfuric acid was the key to promote the spontaneous exfoliating of graphene aggregate.

### Comparative Example 2

Concentrated sulfuric acid (30 mL) and concentrated nitric acid (10 mL) were mixed and stirred in an ice-water bath at 5° C. for 10 min, and 1 g of artificial graphite was added. The mixture was stirred continuously for 6 h in a 20° C. water bath followed by filtration to obtain GICs.

Then, the GICs were slowly added to a mixture of 40 mL of concentrated sulfuric acid and 2 g of potassium permanganate. The mixture was allowed to stand at 35° C. for 6 hours, then filtrated and washed with water. 1 L of deionized water was added and the mixture was shaken for 10 min on an oscillating bed at 500 rpm. The oxidized graphite was not significantly exfoliated, and the partially exfoliated graphene oxide sheet was small in size.

The results showed that sufficient exfoliation of the graphene oxide cannot be achieved only through intercalation and reoxidation of the GIC without addition of an expanding agent.

### Comparative Example 3

1 g of flake graphite was slowly added into a mixture of 40 mL of concentrated sulfuric acid and 2 g of potassium permanganate. The mixture was allowed to stand at 35° C. for 6 hours, and then filtered, and washed with water. 1 L of deionized water was added and the mixture was then shaken for 10 minutes on an oscillating bed at 500 rpm. It was found that the graphite still sank into the bottom of the bottle in the form of particles, indicating that the oxidation of graphite was unsuccessful.

The results showed that low content potassium permanganate can effectively oxidize the graphene aggregate after expansion, but it cannot effectively oxidize flake graphite.

### Comparative Example 4

It was mainly the same as example 8. The difference from Example 8 is that 20 g of chromium trioxide was used. The details were as follows.

1 g of flake graphite (having a carbon content of 95% or more) was mixed with 20 g of chromium trioxide, 7 mL of concentrated hydrochloric acid (38%) was added, and the mixture was stirred at 25° C. in a water bath. After 2 h, the mixture was filtered, and repeatedly washed with water and acetone several times to obtain GICs. Then, 200 mL of hydrogen peroxide (30%) was added and after reacting at room temperature for 2 days, the mixture was filtered and washed with water to obtain worm-like graphene aggregate. Next, it was slowly added to a mixture of 40 mL of concentrated sulfuric acid and 2 g of potassium permanganate (previously mixed). The mixture was stirred at 35° C. for 6 hours, then filtered, and washed with water. 1 L of deionized water was added and the mixture was sonicated in a 500 W ultrasonic water bath for 30 min. The results showed that the radial dimension of the obtained graphene oxide was less than 2 μm, which showed that the oxidized grapheme aggregate led to a significant reduction in the size of the graphene oxide sheet under a strong external field (such as strong ultrasonic treatment) and large-size graphene oxide was not obtained.

### Comparative Example 5

It was mainly the same as example 8. The differences from Example 8 were that 20 g of chromium trioxide was used and 200 mL hydrogen peroxide (30%) was not added. The details were as follows.

1 g of flake graphite (having a carbon content of 95% or more) was mixed with 20 g of chromium trioxide, 7 mL of concentrated hydrochloric acid (38%) was added, and the mixture was stirred at 25° C. in a water bath. After 2 h, the mixture was filtered, and repeatedly washed with water and acetone several times to obtain GICs which were then slowly added to a mixture of 40 mL of concentrated sulfuric acid and 2 g of potassium permanganate. The mixture was left to stand at 35° C. for 6 hours, and then filtered and washed with water. 1 L of deionized water was added and the mixture was stirred at 500 rpm with magnetic stirring for 10 min. The results showed that most of the graphite remained granular form, indicating that the exfoliating was not successful. It was shown that after reoxidation of the intercalated graphite unexpanded by an expanding agent, the successful exfoliating of the graphene cannot be achieved.

1. A method for preparing large-size graphene oxide or graphene, wherein a graphite is firstly intercalated with an intercalating agent, and then the intercalated graphite is expanded with an expanding agent to release the interlayer space and weaken the interlayer interaction forces, then oxidized by an oxidizing agent and exfoliated under a gentle mechanical action to form a uniform graphene oxide dispersion liquid which is finally reduced by using a reducing agent or a heat treatment to obtain a large-size grapheme; including steps:
(1) the graphite and the intercalating agent are stirred and reacted at 0-130° C. for 5 minutes to 48 hours, then added into the expanding agent and soaked at 0-80° C. for 1 hour to 7 days so that the interlayer space is fully released to obtain a graphene aggregate;
(2) the graphene aggregate obtained in step (1) is added into a mixture of an acid and an oxidizing agent, soaked or refluxed at 0-130° C. for 0.1-50 hours, then filtered and washed with deionized water to remove impurities to obtain an oxidized graphene aggregate;
(3) the oxidized graphene aggregate obtained in step (2) is mixed with deionized water and exfoliated under a gentle mechanical action to obtain a graphene oxide dispersion liquid, and the graphene oxide is reduced by using a reducing agent or heat treatment thereby obtaining a large-size, high-conductivity graphene dispersion liquid or graphene film, wherein the content of the graphene oxide aggregate in the suspension liquid is 0.1-50 mg/ml; the thickness of the graphene film is 1-25 μm;
(4) the graphene oxide dispersion liquid or the reduced graphene suspension liquid obtained in step (3) is centrifuged or concentrated by evaporation to obtain graphene oxide or graphene slurry having a high solid content; or is subjected to freeze drying or spray drying to prepare the corresponding graphene oxide or graphene powder.

2. The method for preparing large-size graphene oxide or graphene of claim 1, wherein the graphite as raw material refers to anyone of flake graphite, artificial graphite, expandable graphite and expanded graphite, and the carbon content is greater than 95% and the radial dimension is less than 5 mm.

3. The method of claim 1, wherein the intercalating agent refers to one of ammonium persulfate, potassium dichromate, chromium trioxide, potassium permanganate, potassium ferrate, concentrated sulfuric acid, concentrated hydrochloric acid, concentrated nitric acid, perchloric acid, concentrated phosphoric acid and glacial acetic acid, or a combination thereof in any ratio, the amount of the intercalating agent is 0.1-20 times that of graphite as a raw material, and the concentration of concentrated sulfuric acid, concentrated hydrochloric acid, concentrated nitric acid, perchloric acid, concentrated phosphoric acid or glacial acetic acid used is individually 10-20 mol/L.

4. The method of claim 1, wherein the expanding agent refers to one or more of ammonium oxalate, oxalic acid, potassium oxalate, hydrogen peroxide, sodium carbonate and sodium bicarbonate aqueous solution, its molar concentration is 0.1-10 mol/L, and the amount of the expanding agent is 1-500 times that of the graphite as raw material.

5. The method of claim 1, wherein the acid refers to one or more of concentrated sulfuric acid, concentrated nitric acid, perchloric acid, concentrated phosphoric acid, formic acid, oxalic acid and glacial acetic acid, and the amount of the acid is 1-200 times that of the graphite as raw material.

6. The method of claim 1, wherein the oxidizing agent refers to one of ammonium persulfate, potassium dichromate, potassium permanganate, potassium ferrate, sodium nitrate, potassium nitrate and concentrated nitric acid, or a mixture thereof in any ratio.

7. The method of claim 1, wherein the mass ratio of the oxidizing agent to the graphite as raw material is 0.1-10, preferably 1.5-6.0, more preferably 1.8-4.0, and most preferably 2.0-3.0.

8. The method of claim 1, wherein the gentle mechanical action refers to one of magnetic stirring, mechanical stirring, kneading device, shaker and oscillator, the rotational speed is 10-1000 rpm and the time is 1-120 minutes.

9. The method of claim 1, wherein the reducing agent refers to one of hydrazine hydrate, hydroiodic acid, lithium aluminum hydride, sodium borohydride, sodium hydroxide, sodium citrate, and ascorbic acid, or a mixture thereof in any ratio, the amount of the reducing agent is 0.1-10 times that of the graphite as raw material, the heat treatment refers to a reduction treatment for graphene oxide at 200-2000° C. and the treatment time is 1 second to 60 minutes

10. The method of claim 1, wherein the graphene oxide or graphene has a radial dimension in the range of 85-500 μm.

11. The method of claim 1, wherein the mass fraction of monolayer graphene in the graphene oxide or graphene is ≥75%.

12. The method of claim 1, wherein in the step (1), the mass of the graphite as raw material is ≥0.1 g.

13. A graphene material, wherein its radial dimension is in the range of 85-500 μm, and the mass fraction of monolayer graphene in the graphene material is ≥75%.

14. The graphene material of claim 10, wherein the conductivity of the graphene material is 500-10⁵ S/cm, preferably 550-10⁴ S/cm, more preferably 600-9000 S/cm and most preferably 800-9000 S/cm.

15. An article comprising the graphene material of claim 13 or prepared from the graphene material of claim 13.

16. A method for preparing graphene, comprising the steps of:
(a) reacting a graphite with an intercalating agent under stirring at 0-130° C.;
(b) mixing the stirred reaction product with an expanding agent to obtain a graphene aggregate;
(c) mixing the graphene aggregate obtained in step (b) with an acid and an oxidizing agent to obtain an oxidized graphene aggregate;
(d) mixing the oxidized graphene aggregate obtained in step (c) with deionized water and obtaining graphene oxide after exfoliating;
(e) optionally, reducing the graphene oxide obtained in step (d) by using a reducing agent or heat treatment to obtain a large-size, high-conductivity graphene suspension liquid or graphene film.
